(19) United States
(12) Patent Application Publication
(10) Pub. No.: US 2007/0246156 A1
(43) Pub. Date: Oct. 25, 2007

(54) Composite Structure Made Of Zero-Expansion Material And A Method For Producing Same

(76) Inventors: Heiko Kohlmann, Stromberg (DE); Reinhard Hilscher, Ingelheim (DE); Hauke Esemann, Woerrstadt (DE); Claudia Stolz, Ingelheim (DE); Thomas Werner, Bingen (DE); Ulrich Peuchert, Bodenheim (DE); Jose Zimmer, Ingelheim (DE)

Correspondence Address: HARNESS, DICKEY & PIERCE, P.L.C., P.O. BOX 828, BLOOMFIELD HILLS, MI, 48303, US

(21) Appl. No.: 11/691,697

(22) Filed: Mar. 27, 2007

Related U.S. Application Data
(63) Continuation of application No. PCT/EP05/09648, filed on Sep. 8, 2005.

(30) Foreign Application Priority Data
Sep. 27, 2004 (DE) 10 2004 047 128.2

(51) Int. Cl. B32B 3/00

(52) U.S. Cl. 156/230; 428/44

(57) ABSTRACT

A composite structure (10) is defined, consisting of components made of a zero-expansion material, in particular of a glass ceramic such as Zerodur®, which are joined together by at least one adhesive layer (17, 19, 26, 28, 30, 32). The composite structure (10) has the advantageous properties associated with zero-expansion materials, in particular a very low coefficient of thermal expansion, strength up to 150° C. and minimal outgassing.

### RELATED APPLICATIONS

This application is a continuation application of copending International Patent Application PCT/EP2005/009648 published in German language and claiming priority of German patent application 10 2004 047 128.2 filed on Sep. 27, 2004, the subject matter of which is fully incorporated herein by reference.

### BACKGROUND OF THE INVENTION

The invention relates to a composite structure made of zero-expansion material, in particular of a glass ceramic such as Zerodur®.

Zero-expansion materials, so called, are commonly used in the prior art for numerous applications in precision engineering, inter alia in the optics field.

For example, many astronomical mirrors are made of the Zerodur® glass ceramic produced and marketed by the applicant. Such zero-expansion materials may be lithium-alumino-silicate glass ceramics (LAS glass ceramics), for example, which are partially crystallized by suitable heat treatment of the starting glass, by means of which near-zero thermal expansion in a certain temperature range can be achieved. Another zero-expansion material is marketed by the company Corning under the trademark ULE®. The latter material is a silica glass doped with TiO₂ and produced in a soot process. Another well-known zero-expansion material is Clearceram®.

In the present application, zero-expansion materials are understood to be materials whose coefficient of thermal expansion in the application temperature range, e.g. 0 to 50° C., is less than ±0.5·10⁻⁶/K. In the narrower sense, the term refers to materials whose coefficient of thermal expansion in the application temperature range of 0° to 50° C. is less than ±0.1·10⁻⁶/K, in particular less than ±0.05·10⁻⁶/K, and in particular less than ±0.02·10⁻⁶/K.

Producing a larger optical component from such a zero-expansion material is always a very costly and complicated process, because the respective components must be highly homogeneous and it is therefore imperative to prevent any bubble entrapment or the like. The larger the glass blank, the greater the difficulties for the casting process when producing the blank. When large components made of zero-expansion material are produced, the effort and expense involved is considerably increased by heat treatment, especially, because the heat treatment must be carried out sufficiently slowly during the ceramization process (conversion to glass ceramic) to avoid crack formation due to changes in volume during the ceramization process, and to produce components that are as unstressed as possible.

The weight of a component plays a substantial role in some cases, not only in applications for outer space, but also in other applications. For this reason, for example, mirror telescopes made of zero-expansion materials have long been produced as “lightweight” structures, i.e. the component is machined in order to remove a large part of its volume. In this way, the weight is significantly reduced, for example by about 50% to 85%, without the strength of the respective lightweight component being noticeably diminished relative to a more solid component.

Machining lightweight components involves considerable cost and effort, because only grinding methods can be used and because it is essential to work with special tools, for example with relief grinding tools, in order to produce suitable structures. Furthermore, the range of permissible variation in the machining of solid components to produce lightweight structures is very limited. Only some of the many conceivable structures can be produced in this manner.

### SUMMARY OF THE INVENTION

It is a first object of the invention to disclose a light-weight composite structure made of zero-expansion material, such as glass ceramics, in particular a prism or a mirror, having a good mechanical and dimensional stability.

It is a second object of the invention to disclose a light-weight composite structure made of zero-expansion material that can be produced in a cost-effective way.

It is a third object of the invention to disclose a light-weight composite structure made of zero-expansion material that can withstand elevated temperatures like those that occur during a glass machining operation.

It is a third object of the invention to disclose a light-weight composite structure made of zero-expansion material that is suitable for various applications, such as stages, in mirror telescopes, as components for microlithography, in LCD lithography and as optical banks and the like. In addition to terrestrial applications, applications in outer space shall be possible.

A suitable method for producing such a composite structure shall likewise be disclosed.

According to the invention these and other objects are achieved by a composite structure of zero-expansion material, in particular a prism or a mirror, comprising a plurality of components made of a zero-expansion material, in particular of a glass ceramic such as Zerodur®, said components being bonded together by at least one adhesive layer.

With regard to the method, the object of the invention is achieved by a method in which a plurality of components consisting of a zero-expansion material, in particular of a glass ceramic such as Zerodur®, are joined together by at least one adhesive layer.

The technical problem of the invention is completely solved in this manner.

The invention overcomes a prejudice in the prior art against the use of adhesive bonds in processing zero-expansion materials. Until now, it has always been assumed that precision components made of zero-expansion material must always be integral in structure in order to ensure a sufficiently high level of precision and particularly to obtain the advantageously low, near-zero coefficient of thermal expansion. The invention shows that composite structures made of zero-expansion material can be produced with sufficiently high precision even when using adhesive compounds.

It has also been shown that it is possible to fulfil the demanding requirements that zero-expansion materials are expected to meet. These include:
sufficiently high strength at temperatures up to 150° C.,
strength in warm and humid conditions, such as those which can occur during grinding, or when the materials are used under such climatic conditions,
low outgassing levels,
sufficiently low thermal expansion.

If the adhesive layer is sufficiently thin, the thermal expansion properties are impaired only to an insignificant extent by the much greater thermal expansion of the adhesive layer, with the result that a composite structure made of components bonded together can meet the technical specifications for most uses, also and especially with regard to thermal expansion.

For this reason, it is preferred according to the invention that each adhesive layer has a thickness of 1 mm at most, preferably of 0.5 mm at most, more preferably of 0.2 mm at most, and particularly preferably of 0.1 mm at most.

This enables the composite structure according to the invention to have a low coefficient of thermal expansion of at most 0.1·10⁻⁶/K, preferably of 0.05·10⁻⁶/K at most and even more preferably of at most 0.02·10⁻⁶/K in the temperature range between 0° and 50° C.

The adhesive layer preferably consists of an epoxy resin adhesive.

The latter may be a two-component adhesive that can be cured at room temperature.

An adhesive layer consisting of an adhesive produced from an epoxy resin as base material and a modified amine as hardener, for example an adhesive of the Loctite® Hysol® type, in particular Loctite® Hysol® 9491, has proved especially suitable.

Such an adhesive is sufficiently stable, has a low outgassing level and still has sufficient strength in a moist environment at higher temperature. It is also particularly advantageous for operations at temperatures ranging from room temperature to 150° C., and its coefficient of thermal expansion, which is approximately 6.3·10⁻⁵/K in the temperature range between 20° and 70° C., is sufficiently low in sufficiently thin adhesive layers to produce composite structures whose (total) coefficient of thermal expansion is lower than ±0.5·10⁻⁶/K, in particular lower than +0.1·10⁻⁶/K and which can even be in the order of ±0.02·10⁻⁶/K.

As an alternative, an adhesive layer consisting of a one-component epoxy resin adhesive that can be cured at a temperature of approximately 70° to 150° C. has also proved advantageous, whereby Loctite® Hysol® 9509, for example, can be used advantageously. Loctite® Hysol® 9502 and Epo-Tek® 353 ND-T have proved to be additional advantageous alternatives.

According to another embodiment of the invention, the composite structure comprises a plurality of tubular spacers that are arranged parallel to each other, are bonded together at their outer surfaces and are bonded at their first end to a mirror component and at their second end to a support component.

The tubes may have a circular or a polyhedral cross-section, for example. With such an embodiment, it is possible to produce particularly stable and high-quality composite structures that are important for telescope applications, especially.

Alternatively, in one embodiment as a prism, the composite structures can also be produced from single plate-shaped or cuboidal elements that are bonded together.

In a preferred development of the invention, the adhesive layer consists of an adhesive having a mass loss of less than 1 wt.-% after curing for 24 hours at 1500C.

When using such an adhesive, it is possible to avoid disadvantages that may arise due to the higher temperatures during final processing of the composite structures. Such final processing generally involves polishing and coating, whereby the temperatures can rise to about 100° C. to 150° C. Undesired mass loss can thus be avoided in this manner, while simultaneously avoiding any impairment of the produced composite structure due to outgassing products that could be precipitated onto the optically active surface of the composite structure.

According to another embodiment of the invention, two components with abutting surfaces are joined together, at least one recess being provided in the surface of at least one of said components, the recess forming a cavity with the opposite surface of the other component, wherein only the cavity is filled with adhesive and cured at a temperature higher than the application temperature.

This has the advantage that the geometry of the composite body, in particular its coefficient of thermal expansion, is determined primarily by the bonded components made of zero-expansion material, and that the adhesive compound in the cavity has only an insignificant and mainly local influence.

According to yet another embodiment of the invention, two components made of a zero-expansion material having a negative coefficient of thermal expansion in the application temperature range are bonded together by an adhesive layer having a positive coefficient of thermal expansion in the application temperature range.

In this embodiment, the size of the components, their coefficient of thermal expansion, the thickness of the adhesive layer and its coefficient of thermal expansion are preferably matched with each other in such a way that the total coefficient of thermal expansion of the composite structure is minimized in the application temperature range.

In this way, it is possible to produce a composite structure having a minimized coefficient of thermal expansion in the application range, whereby said coefficient can even be zero.

The composite structures of the invention can be deployed in every conceivable field of application requiring zero-expansion materials, and in which possible weight savings and/or cost savings are desired.

These include uses as stages, in mirror telescopes, as components for microlithography, in LCD lithography and as optical banks and the like. In addition to terrestrial applications, applications in outer space are also conceivable.

It is self-evident that the features of the invention as mentioned above and to be explained below can be applied not only in the combination specified in each case, but also in other combinations or in isolation, without departing from the scope of the invention.

### BRIEF DESCRIPTION OF THE DRAWINGS

Additional features and advantages of the invention derive from the following description of preferred embodiments, with reference to the drawings in which

FIG. 1 shows, in an elongated sectional view, a first embodiment of a composite structure according to the invention, for use as a concave mirror;

FIG. 2 shows a cross-section of the composite structure of FIG. 1;

FIG. 3 shows an alternative embodiment of a composite structure according to the present invention, in a sectional view;

FIG. 4 shows another embodiment of a composite structure according to the invention, in a sectional view, and

FIG. 5 shows a simplified schematic view of a composite structure according to the invention, in the form of a prism used for an LCD stepper device in the field of LCD lithography.

### DETAILED DESCRIPTION OF PREFERRED EMBODIMENTS

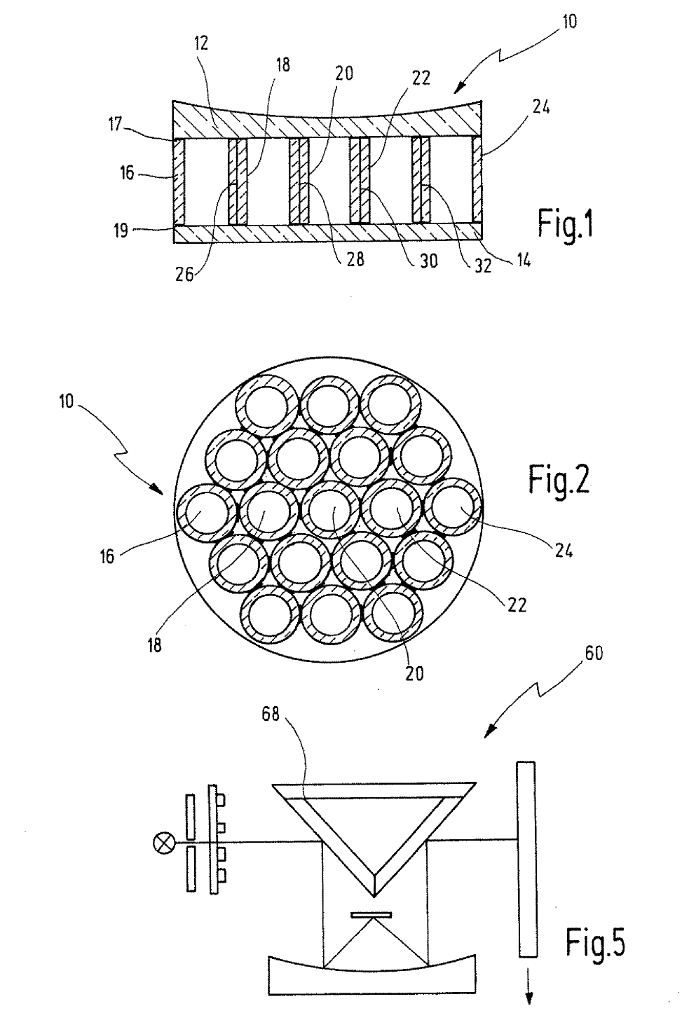

FIG. 1 shows a schematic view of a possible embodiment of a composite structure according to the invention, in the form of a mirror, and labeled in its entirety with reference numeral 10.

Composite structure 10 has a mirror component 12, a support component 14 and a plurality of tubes 16, 18, 20, 22, 24, all of which consist of the Zerodur® glass ceramic.

Mirror component 12 is concavely ground at its outer surface and is generally provided with a reflective coating (not shown) after it has polished accordingly to its final dimensions. On its underside, mirror component 12 has a plane surface. Support component 14 is a flat cylindrical component having two planar faces. As can be seen in greater detail from FIG. 2, in particular, mirror component 12 is now joined to mirror component 12 by a plurality of components in the form of tubes, of which only tubes 16, 18, 20, 22, 24 are labeled in FIG. 1. The tubes are ground at both ends to make them planar. Tubes 16-24 are each joined at their ends by an adhesive layer 17 and 19 to mirror component 12 and support component 14, respectively. Tubes 16, 18, 20, 22, 24 are also joined to the outer surfaces of the adjacent tubes by an adhesive layer 26, 28, 30, 32.

Adhesive layers 17, 19, 26, 28, 30, 32 consist of the Loctite® Hysol® 9491 adhesive, which is a special two-component epoxy resin adhesive that hardens at room temperature and can be obtained from Loctite Co., Rocky Hill, Conn., USA (a member company of the Henkel Group). The adhesive is specifically applied at its axial ends in such a thickness that the respective adhesive layers 17, 19 have a thickness of about 0.5 mm at most, preferably of 0.2 mm at most and most preferably of 0.1 mm at most. The coefficient of thermal expansion of this adhesive is about 63·10⁻⁶/K in the temperature range between 20° and 70° C. The coefficient of thermal expansion of Zerodur® in the highest quality level is about 0±0.02·10⁻⁶/K in this temperature range.

For a component of 100 mm total length with an adhesive layer of 0.1 mm thickness, the resultant total expansion αₜₒₜₐₗ is approximately 0.04·10⁻⁶/K to 0.08·10⁻⁶/K. If two adhesive layers with a total thickness of 0.2 mm are used, the resultant coefficient of thermal expansion αₜₒₜₐₗ is about 0.1·10⁻⁶/K to 0.2·10⁻⁶/K.

So although the adhesive layer has a relatively high coefficient of thermal expansion, the combination of very thin adhesive layers results in a sufficiently low thermal expansion that is sufficiently low for most applications. The adhesive layers are therefore applied with the smallest possible thickness, typically of about 0.1 mm.

The preferred adhesive Loctite® Hysol® 9491 has a good shear strength at room temperature and also a sufficiently good shear strength at higher temperatures of up to 150° C.

When processing such composite structures, polishing and coating steps are performed by the end user (the mirror manufacturer), whereby a maximum temperature in the order of up to about 150° C. can be reached. The preferred Loctite® Hysol® 9491 adhesive has sufficiently high strength at such higher temperatures. The preferred adhesive is also sufficiently resistant to climatic influences, such as those which can arise during polishing or under the respective climatic conditions, such as high humidity.

The preferred Loctite® Hysol® 9491 adhesive has been selected from a series of epoxy resin adhesives.

The test criteria measured were:

1. Strength

The priority here was high pressure-shear strength, for which a pressure shear test was conducted using samples with ground surfaces and polished edges, whereby the individual samples measured 10×22 mm².

2. Resistance to Climatic Influences

Strength was measured after 100 hours at 85° C. and a relative humidity (RH) of 85% (at conditions otherwise identical to 1. above).

3. Heat Resistance

Strength was measured after heat treatment lasting 24 hours at 150° C., under conditions otherwise identical to those in 1. above at room temperature.

Strength was also determined at 150° C., at conditions otherwise identical to those in 1. above.

4. Outgassing Properties

The sample weight was measured before and after heat treatment at 150° C. A thermogravimetric analysis (TGA) was also performed.

Such tests were conducted on many adhesives selected from the large number of available epoxy resin adhesives. The use of UV-cured adhesives was excluded as unsuitable from the outset, because no sufficiently homogenous bond can be achieved with such adhesives.

Table 1 shows an overview of the shortlisted and tested adhesives.

The results of the strength tests on the various adhesives are summarized in Table 2.

As previously mentioned, pressure shear tests were conducted on ground surfaces with polished edges and a sample size of 10×22 mm². The columns show the results at room temperature, after 100 hours at 85° C. and 85% relative humidity, after 24 hours at 150° C., and at 150° C.

Table 3, finally, shows the outgassing properties of the adhesives, whereby the weight loss in percent following heat treatment at 150° C. for 24 hours is shown.

The preferred Loctite® Hysol® 9491 adhesive shows good strength values for all test criteria, on the one hand, as well as low outgassing levels, on the other hand. After 24 hours at 150° C., a weight loss less than 1 wt.-% was measured. This adhesive also has the advantage that it hardens at room temperature.

Loctite® Hysol® 9509, which has particularly high strength values combined with low outgassing levels, is considered to be another preferred adhesive.

However, the latter is a one-component epoxy resin adhesive that must be cured at 120° C. (preferably for 60 minutes at 120° C.).

If this disadvantage, which involves greater production effort, is acceptable, this adhesive is preferred because it enables greater strength to be achieved.

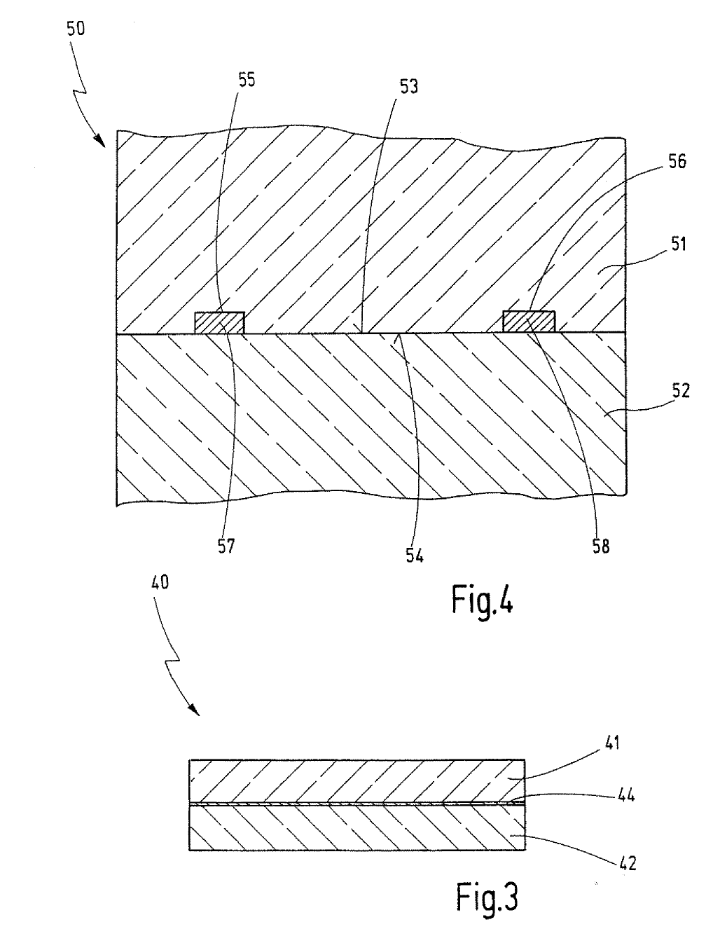

FIG. 3 shows another possible embodiment of a composite structure according to the invention and made of Zerodur®, which is labeled in its entirety with reference numeral 40. The structure comprises a first component 41 and a second component 42, both of which consist of Zerodur®. Components 41, 42 are bonded together at their surfaces. It is understood that the Figure shows merely one possible geometry and that the thickness of the adhesive layer 44 is not true to scale.

The thickness of adhesive layer 44 is very small and, as already stated, is preferably less than 0.2 mm, and particularly preferably about 0.1 mm.

As mentioned above, the thermal expansion of the composite body 40 is thus kept very small, despite adhesive layer 44.

FIG. 4 shows another possible embodiment of a composite structure according to the invention and made of Zerodur®, which is labeled in its entirety with reference numeral 50. This structure is a composite structure consisting of two components 51 and 52. The two components 51 and 52 consist of Zerodur®, for example. Components 51, 52 are joined to each other at their two planar surfaces 53 and 54. The bond is achieved with an adhesive which is received only in cavities 55, 56 formed between the two surfaces 53 and 54, as shown in 57 and 58. The join is adhesive-free outside cavities 55, 56. The adhesive is cured at a temperature above the application range, for example at 150° C. when the application range extends to a maximum of 130° C.

In operation, the thermal expansion properties are mainly determined by the expansion properties of components 51, 52 and only to an insignificant extent by the adhesive received in cavities 55, 56. The effects of the adhesive, such as thermal expansion, stressing or the like caused by the adhesive, are locally confined to a substantial extent and have only a slight effect on the properties of composite body 50.

The adhesive used is preferably Loctite® Hysol® 9491 or Loctite® Hysol® 9509.

FIG. 5 shows in a schematic view a possible use in LCD lithography of a composite body according to the invention, in the form of a prism 68 in an LCD stepper 60. Prism 68 is assembled from components made of zero-expansion material such as Zerodur®, and which are bonded together. This results in a substantial saving in weight compared to a solid construction design of prism 68. Of course, the adhesive layers are always provided at such places in the composite structure that optically active surfaces are not adversely affected.

It is understood, of course, that any other composite structures can be produced using the method of the invention.

Another option when producing composite structures by bonding components made of zero-expansion material is to use a zero-expansion material that has a slightly negative coefficient of thermal expansion in the application range, for example between 0° and 50° C.

In this case, the geometrical dimensioning of the components, the thickness of the adhesive layer and the coefficient of thermal expansions of the zero-expansion material (negative) and the adhesive (positive) can be matched in such a way that the coefficient of thermal expansion of the composite structure is minimized in the application range and effectively amounts to zero.

The heat treatment during production of a lithium-alumino-silicate (LAS) glass ceramic such as Zerodur® can be controlled in such a way, for example, that the coefficient of thermal expansion of the zero-expansion material Zerodur® is −0.1·10⁻⁶/K for an application range of 0° to 50° C.

This means that the positive thermal expansion of the adhesive can be totally compensated. A composite structure consisting of two components made of such material, in which the total length of the components is 100 millimeters, the thickness of the adhesive layer is 0.2 mm and the coefficient of thermal expansion is 50·10⁻⁶/K thus has total expansion of exactly zero.

TABLE 1

| Producer | Trade name | Curing |
|---|---|---|
| 3M | DP 760 | Room temperature (RT) |
| 3M | F9469PC | Transfer tape, at RT |
| Dymax | OP24 RevB | RT |
| Polytec | Epo-Tek 353 ND-T | 30 minutes at 80° C. |
| Loctite | Hysol 9491 | RT |
| Loctite | Hysol 9492 | RT |
| Loctite | Hysol 9502 | 30 minutes at 120° C. |
| General Electric | RTV 615 | 60 minutes at 100° C. |
| MasterBond | EP24 HT-2 | RT |
| Loctite | Hysol 9509 | 60 minutes at 120° C. |

TABLE 2

| | | F [N] after | F [N] after | |
|---|---|---|---|---|
| | Fₘₐₓ[N] | 100 hrs at | 24 hrs | F [N] |
| Adhesive | at RT | 85° C./85% RH. | at 150° | at 150° C. |
| DP 760 | 11547 ± 2642 | 4824 ± 2985 | 5258 ± 2691 | 1409 ± 1322 |
| F 9469 PC | 340 ± 33 | 219 ± 25 | 346 ± 22 | 122 ± 24 |
| OP24 RevB | 9513 ± 935 | 4919 ± 896 | 7775 ± 2597 | 2797 ± 863 |
| Epo-Tek353ND-T | 17634 ± 1537 | 13802 ± 1813 | 17353 ± 813 | 9300 ± 3271 |
| Hysol 9491 | 12658 ± 361 | 6966 ± 1550 | 11821 ± 541 | 6822 ± 752 |
| Hysol 9492 | 7320 ± 2961 | 4987 ± 829 | 8831 ± 1732 | 587 ± 277 |
| Hysol 9502 | 10758 ± 5427 | 12952 ± 751 | 13623 ± 4725 | 11294 ± 417 |
| RTV 615 | 1669 ± 109 | 1361 ± 136 | 2101 ± 258 | 1256 ± 129 |
| Hysol 9509 | 18571 ± 586 | 16488 ± 521 | 18285 ± 929 | 14404 ± 585 |
| EP42 HT-2 | 13016 ± 370 | 12498 ± 709 | 14352 ± 516 | 5702 ± 2049 |

TABLE 3

| | | Weight loss [wt.-%] |
|---|---|---|
| Producer | Trade name | after 24 hrs at 150° C. |
| 3M | DP 760 | 0.95 |
| 3M | F9469PC | 2.87 |
| Dymax | OP24 RevB | 6.02 |
| Polytec | Epo-Tek 353 ND-T | 0.53 |
| Loctite | Hysol 9491 | 0.84 |
| Loctite | Hysol 9492 | 2.17 |
| Loctite | Hysol 9502 | 0.39 |
| General Electric | RTV 615 | 0.82 |
| MasterBond | EP24 HT-2 | 0.11 |
| Loctite | Hysol 9509 | 0.12 |

1. A composite structure made of zero-expansion material, comprising a plurality of components made of zero-expansion material, said components being joined together by at least one adhesive layer, said adhesive layer comprising an adhesive having a mass loss of less than 1 wt.-% after curing for 24 hours at 150° C.

2. The composite structure of claim 1, comprising at least two components with abutting surfaces, wherein at least one recess is provided in the surface of at least one of the components, said recess forming a cavity with the opposite surface of the other component and said cavity being filled with an adhesive having been cured at an elevated temperature.

3. The composite structure of claim 1, wherein the adhesive layer consists of an epoxy resin adhesive that can be cured at room temperature.

4. The composite structure of claim 1, wherein each adhesive layer has a thickness of 1 millimeter at most.

5. The composite structure of claim 2, wherein each adhesive layer has a thickness of 0.5 mm at most.

6. The composite structure of claim 1, having a coefficient of thermal expansion of 0.1·10⁻⁶/K at most in the temperature range between 0 to 50° C.

7. The composite structure of claim 5, having a coefficient of thermal expansion of 0.02·10⁻⁶/K at most in the temperature range between 0 to 50° C.

8. The composite structure of claim 1, wherein said adhesive layer comprises a one-component epoxy resin adhesive that can be cured at a temperature between 70° and 150° C.

9. The composite structure of claim 1, wherein said adhesive is selected from the group formed by Loctite® Hysol® and Epo-Tek®.

10. A composite structure made of zero-expansion material, comprising a plurality of components made of zero-expansion material, said components being joined together by at least one adhesive layer, said adhesive layer comprising an adhesive having a coefficient of thermal expansion of 0.5·10⁻⁶/K at most in the temperature range between 0 to 50° C.

11. The composite structure of claim 10, having a coefficient of thermal expansion of 0.02·10⁻⁶/K at most in the temperature range between 0 to 50° C.

12. The composite structure of claim 10, wherein said adhesive layer consists of an adhesive having a mass loss of less than 1 wt.-% after curing for 24 hours at 150° C.

13. A composite structure made of zero-expansion material, comprising at least two components made of zero-expansion material having a negative coefficient of thermal expansion in a given application temperature range, said components being joined together by at least one adhesive layer, having a positive coefficient of thermal expansion in a desired application temperature range.

14. The composite structure of claim 13, wherein the size of the components whose coefficient of thermal expansion, thickness of adhesive layer and coefficient of thermal expansion of the latter are matched with each other in such a way that the total coefficient of thermal expansion of the composite structure is minimized in the application temperature range.

15. The composite structure of claim 14, wherein the adhesive layer consists of an epoxy resin adhesive that can be cured at room temperature.

16. The composite structure of claim 15, wherein said adhesive layer consists of an epoxy resin as a base material and a modified amine as a hardener.

17. The composite structure of claim 15, wherein said adhesive layer comprises a one-component epoxy resin adhesive that can be cured at a temperature between 70° and 150° C.

18. The composite structure of claim 15, wherein said adhesive is selected from the group formed by Loctite® Hysol® and Epo-Tek®.

19. The composite structure of claim 13, wherein the adhesive layer consists of an adhesive having a mass loss of less than 1 wt.-% after curing for 24 hours at 150° C.

20. A method for producing a composite structure made of zero-expansion material, wherein a plurality of components made of zero-expansion material are joined together by at least one adhesive layer.
